(19) United States
(12) Patent Application Publication
(10) Pub. No.: US 2016/0012060 A1
(43) Pub. Date: Jan. 14, 2016

(54) Method and process for recording and displaying agreements and disagreements regarding digital content

(71) Applicant: David Keith Pechacek, Hayward, WI (US)

(72) Inventor: David Keith Pechacek, Hayward, WI (US)

(21) Appl. No.: 14/120,955

(22) Filed: Jul. 14, 2014

(51) Int. Cl. G06F 17/30; H04L 29/08

(52) U.S. Cl. CPC G06F 17/30058; H04L 67/32

(57) ABSTRACT

A method and process executed on a computer server for connecting discrete pieces of digital content created by many people into logical structures whereby individuals may express agreement and disagreement with each piece of content, while enforcing that no person may contradict their own agreement or disagreement, enforced through a process of calculating implied positions based upon a structure of premises, each of which is a separate piece of digital content, that may be attached to each piece of digital content. Further, a method and process for combining similar pieces of digital content into a single representation of such content under the guidance of the individual creators of such digital content.

### TECHNICAL FIELD

This invention relates to the conveying of the stated and/or calculated attitudinal positions of people—whether they agree, disagree or have no position—upon digital works exchanged over a network of computers including but not limited to the Internet.

### BACKGROUND

Computer networks such as the public Internet and private intranets have provided a convenient way for people to communicate with each other, and many forms of communication have taken advantage of these networks. Some forms of communication, such as blogs, discussion forums, collaboration applications and social networking web sites, provide ways for large and small groups to engage in discussions about various topics. Also, many newspapers have created web sites to convey news stories, and they often provide a way for readers to engage in conversation about those news stories.

Discussions forums in existing network applications and web sites often include a way for people to reply to each other, and often times they allow replies to replies and so on to some predefined or infinite level of reply nesting. This often results in many disjointed conversations that rarely achieve conclusion, a meeting of the minds, or even an agreement to disagree.

In addition to discussions, many websites provide icons or buttons for a user to click to express a previously defined attitude, such as thumbs up, thumbs down, like, dislike, positive, negative, recommend, don't recommend, star ratings and other ratings scales. Most of these attitudinal indicators do not necessarily indicate clearly whether a person agrees or disagrees with what was presented, but rather whether they like the content or dislike it or whether they like the person or dislike the person creating the content. There are other indicators as well that convey other specific or non-specific attitudes.

A simple example of how information is transferred from person to person today is through a blog or social networking web site, where typically the owner of the blog or site posts information, pictures, sound and/or other digital work, and others can comment on that information using plain text and/or html-based formats. Some of these blogs or social networking sites also include some of the predefined attitudinal indicators as described above.

In addition to these communications mechanisms, collaborative web sites provide a means to work as a group on common documents. Many of these sites also provide a means of discussing differences of opinion or representations of fact through discussion forums, and some provide predefined methods of deciding upon which opinion or representation of fact will be used.

A common form of website is the wiki, which provides a way for people to create documents together as a group. Wikipedia, for example, allows anyone to modify an encyclopedia entry. They also provide a means of working through disagreements about which content should appear, but in cases where a dispute exists over what should appear, a human or an algorithm must generally make the final decision, and that decision determines what appears. This can lead to errors in the information that is ultimately presented to the observer without a clear indication of the controversial nature of the information. In many cases, there is no absolute truth or correct way to display the information, so it often comes down to differences of opinion and some kind of weighting scheme to determine which person's opinion or representation of fact is used.

In general, each time a person posts a representation of fact, an opinion, an attitude, or other information of any kind, it is often disjointed from other information they or others have posted on the network, except for connections by the use of hyperlinks. Hyperlinks can be used to markup HTML content to provide links to previous information from other locations on the network in a context of the creator's choosing.

The main problem with hyperlinks is that the link itself doesn't provide any context for the purpose of the link, and so no standardized meaning is attached. The meaning is often described in the name of the link, the surrounding text or graphics or both. The number of possible contexts and meanings for a hyperlink are virtually infinite. Some websites provide a predefined set of hyperlinks for taking a certain action based upon the information provided, but these conventions are determined by each web site, and there exists little standardization in the semantics of those hyperlinks with regard to the attitudes of the people reading and creating content.

Until now, there has been no effective, consistent way for participants in network communications with others to determine the consistency of each piece of content with other pieces of content, and to prevent creators of such content from presenting contradicting representations of fact, opinion or attitudes regarding the content created by themselves or others.

As a result of these deficiencies in existing solutions, there is no synchronization in most of the discussions that occur on computer networks regarding controversial or complex subjects. Most conversations are disjointed and spread across multiple platforms, formats, web sites, blogs, social networks, and other data sources, and most creators of information never provide a verifiable means of checking the consistency of their viewpoints. This makes it difficult to judge the trustworthiness of information presented on the Internet and other computer networks.

Thus there remains a considerable need for a reliable means of judging the trustworthiness and consistency of sources of information over the public Internet and other computer networks.

### SUMMARY OF THE DISCLOSURE

The present invention is directed to a method and process for connecting discrete pieces of digital content created by a multitude of people into tree structures of premises, wherein each person cannot indicate disagreement with any premise of any piece of digital content with which they indicate agreement, which allows each person to view the structure of premises created by or agreed to by any other person.

The connection of content takes place on a server computer or a group of server computers, herein referred to as the server. The server is composed of a general-purpose processor, general-purpose memory and optionally some form of long-term storage. The server may or may not store the original content, but it does store a uniquely identifiable reference to the original content so it can recall the original content upon request to be displayed to a person on their display. The process of submitting new content to the server, including references to existing content as premises of the new content, is herein described as registering new content.

Graphical views of premise trees from any person's point of view can be requested and returned by the server in some embodiments, allowing people to view the full context of a discussion from any person's point of view.

One embodiment may store a full copy of the original content such that access to the content is always available upon request regardless of the state of other servers upon which the original content may also appear. This embodiment might also include a means for content to be registered without storing the content upon special request by the submitter, in which case a unique identifier is returned to the requestor so they may direct readers of their content to its registered place on the server.

One embodiment is also directed to a method of representing a multitude of similar discrete pieces of digital content created by a multitude of people as only one of the multitude, using a crowd-sourced method of eliminating unnecessary duplication of content, so that many people can communicate about the same representation of similar content. Some embodiments may not include this process.

Using any computing device to create a piece of digital content, which may consist of any digital data such as text, HTML content, graphics, or any other digital content that can be combined into a single discrete package of digital data, each person may submit their piece of content to a central server or a group of central servers to be connected to other pieces of digital content already existing in the server or servers as premises of the new piece of content, meaning that the person creating the new content agrees with all of the premises they choose to attach, and they also agree with all of the premises in the tree of premises under each of those premises.

Some people might often use the same premises for many of their new content submissions, and the premises they use most often might indicate biases of that person with regard to subjects under discussion.

If a person responds directly to an existing piece of content by indicating agreement with that piece of content and adding their own new content, the existing content and the new content are considered part of the same conversational thread.

The present invention, allowing people to view previous content registered in the server, also allows people to indicate agreement or disagreement with each piece of content they can view.

Each time a person indicates an agreement or disagreement with a piece of digital content, whether through a direct request to agree or disagree, or whether through the implied agreement that takes place when attaching premises to a newly registered piece of content, all previous content for which the person has expressed agreement or disagreement is checked for consistency with the new agreement or disagreement using premise logic, and any contradictions that are found are removed by retraction of content or retraction of the conflicting expression.

The process of finding and eliminating contradictions using premise logic takes place by analyzing the premise trees of existing content, enforcing the rules that 1) a person cannot both agree and disagree with the same content and 2) a person agrees to all premises in the premise tree of any content they agree with.

Some embodiments use premise logic to calculate a position of agreement or disagreement for a user for each digital work even if they haven't indicated a position for that digital work through a direct request. Such calculations of position also count the number of levels through the premise tree that much be searched to provide a definitive position for the user regarding the digital work. This count is called the indirection level, and in some embodiments is displayed using visual cues such as color, or numerical level, or any other visual cue that conveys a relative level.

One embodiment also combines similar content into a single representation by allowing people to submit requests to the server that creators of similar content combine their content to be represented as one of those pieces of content in a process of deferral. Further, by chaining multiple deferrals together, many similar pieces of deferred content are further condensed to a single representation using the judgment of many people.

Various objects, features, aspects and advantages of the present invention will become more apparent from the following detailed description of preferred embodiments of the invention, along with the accompanying drawings in which like numerals represent like components or processes.

### BRIEF DESCRIPTION OF THE DRAWINGS

FIG. 1 is a block diagram of a system for displaying digital content according to an embodiment.

FIG. 2 is a schematic of an exemplary depiction of a premise tree 200 according to an embodiment of the disclosure.

FIG. 3 is a schematic of an example of the structure of a conversational thread according to an embodiment of the disclosure.

FIG. 4 is a schematic of a method for determining an indirection level for a disagreement with a UIDW an example of how a disagreement within a premise tree can allow a calculated disagreement to be displayed according to an embodiment of the disclosure.

FIG. 5 is a schematic of a deferral chain according to an embodiment of the disclosure.

FIG. 6 is exemplary tabular depiction of metadata fields of a uniquely identifiable digital work according to an embodiment of the disclosure.

FIG. 7 is a flowchart of a method for executing a main process, which dispatches events to an appropriate auxiliary process according to an embodiment of the disclosure.

FIG. 8 is a flow diagram of a View UIDW subroutine according to an embodiment of the disclosure.

FIG. 9 is a flow diagram of a create UIDW subroutine according to an embodiment of the disclosure.

FIG. 10 is a flow diagram of a contradiction list subroutine according to an embodiment of the disclosure.

FIG. 11 is a flow diagram of an agreement list subroutine according to an embodiment of the disclosure.

FIG. 12 is a flow diagram of a disagreement list subroutine according to an embodiment of the disclosure.

FIG. 13 is a flow diagram of a premise subroutine according to an embodiment of the disclosure.

FIG. 14 is a flow diagram of a storage subroutine according to an embodiment of the disclosure.

FIG. 15 is a flow diagram of a UIP position subroutine according to an embodiment of the disclosure.

FIG. 16 is a flow diagram of a UIP agreement subroutine used by the process in FIG. 15.

FIG. 17 is a flow diagram of a UIP disagreement subroutine used by the process in FIG. 15.

FIG. 18 is a flow diagram of a silent agreement request subroutine according to an embodiment of the disclosure.

FIG. 19 is a flow diagram of a deferral request subroutine according to an embodiment of the disclosure.

FIG. 20 is a flow diagram of a process deferral subroutine according to an embodiment of the disclosure.

FIG. 21 is a flow diagram of a deferral subroutine, which is a sub-process of FIG. 20.

FIG. 22 is a flow diagram of a deferral response subroutine according to an embodiment of the disclosure.

FIG. 23 is a flow diagram of a deferral link update subroutine, which is a sub-process of FIG. 22.

### DETAILED DESCRIPTION

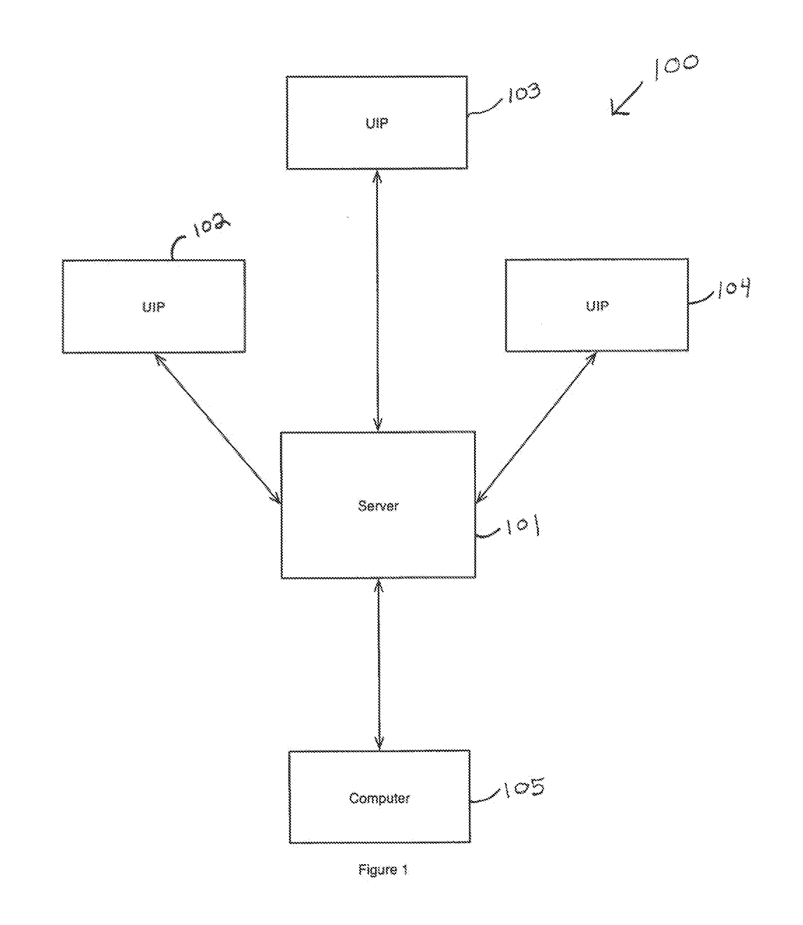

In FIG. 1, a block diagram of a system 100 for displaying digital content is shown according to an embodiment. At a minimum, each person interacting with the present invention must use a computer 105 to create digital content 102a-c, and provide requests to a server 101, which is where most of the present invention's operations take place.

In one embodiment, server 101 connects digital content 102a-c, which is provided by individual persons, into a premise tree utilizing a programmable device such as computer, mobile device, personal digital assistant (PDA) or other computing device in the main embodiment of the present invention. Each premise tree associated with a digital content 102a-c can be viewed on the same or other computers, such as computer 105 connected to server 101.

As discussed herein, each person that creates content, such as digital content 102a-c, is a Uniquely Identifiable Person (UIP) within the domain of operation of the invention, and when they create a Uniquely Identifiable Digital Work (UIDW) they are considered the creator of that work. A unique identifier for each UIP may be assigned by any means, including logging in to a system with a user name and password, or by using a third party identification mechanism that results in an identifier that can be used by the present invention and stored in a metadata of a UIDW.

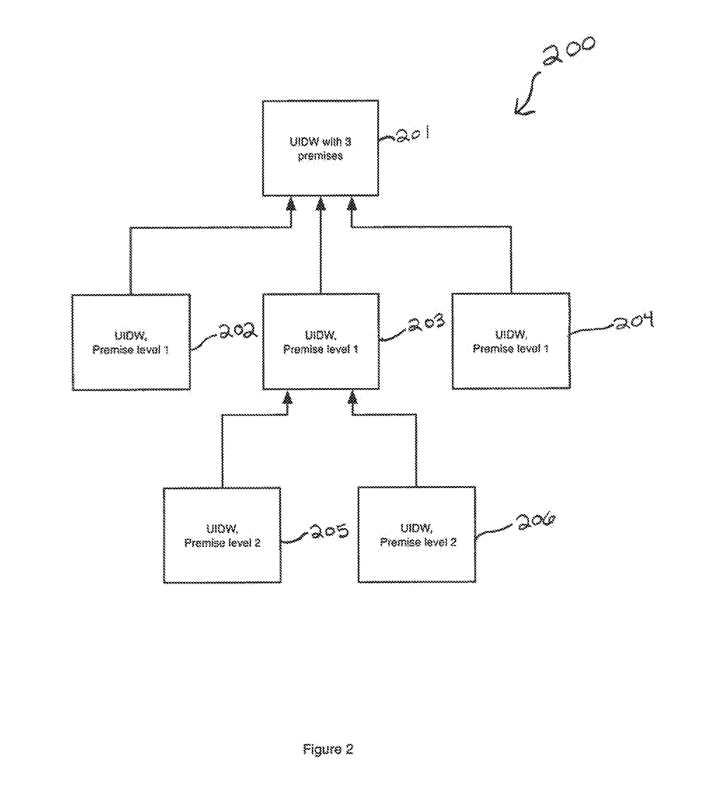

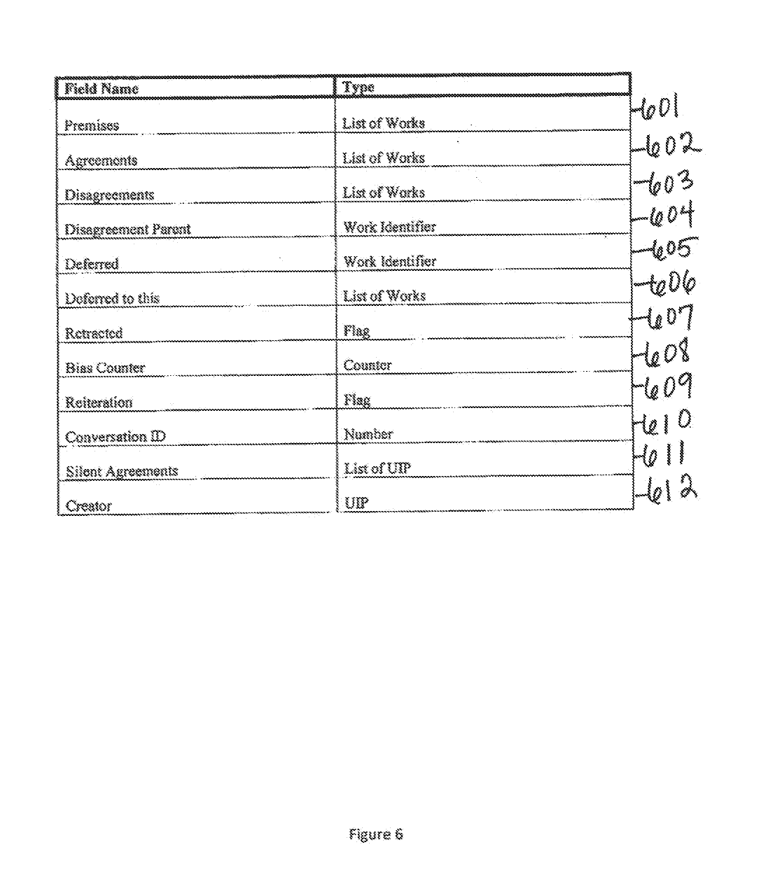

In FIG. 2, an exemplary depiction of a premise tree 200 produced by server 101 is shown according to an embodiment. In one embodiment, premise tree 200 can comprise a plurality of UIDWs 201-206. Although generally referred to herein as a UIDW, a UIDW can comprise any collection of information represented in any binary format that is unique from all other digital works within the same domain, to which the metadata, as discussed with reference to FIG. 6, is attached and stored in server 101.

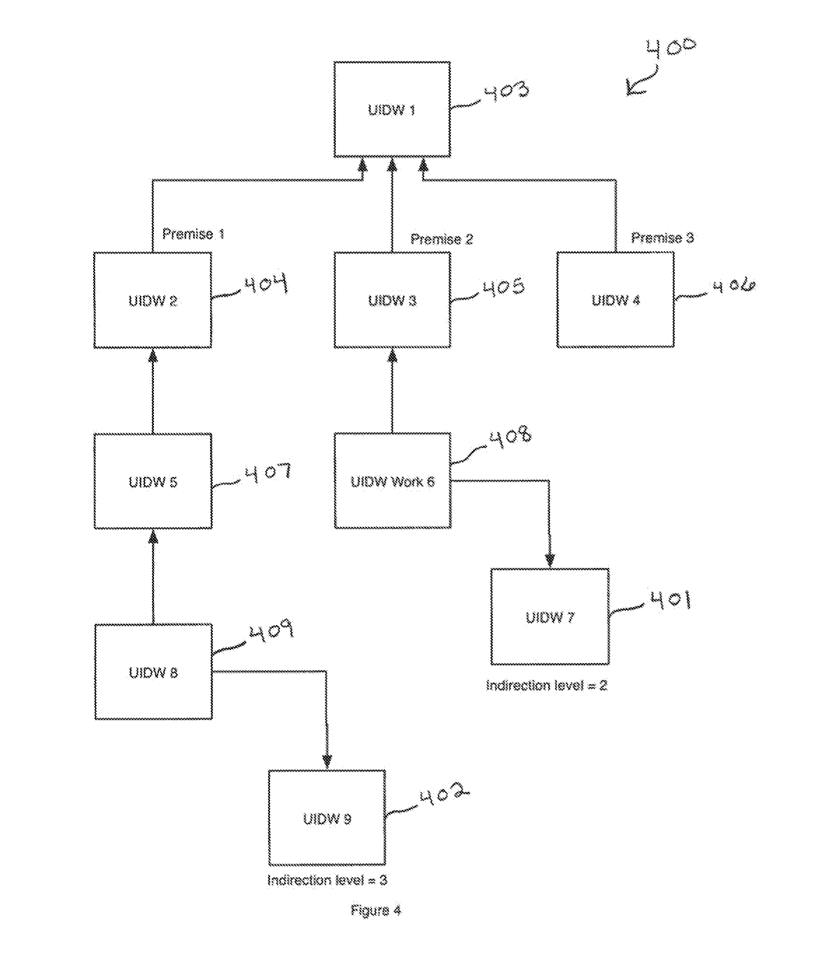

As depicted in FIG. 2, UIDWs 202-204 each represents premise of UIDW 201, where a premise is defined as a UIDW for which agreement is necessary before agreement with the UIDW containing the premise is possible. In other words, a UIP may only be in agreement with a UIDW if the UIP is also in agreement with all of the listed premises of that UIDW. 205 and 206 represent premises of 203 according to the same rules, and 202-206 all must be agreed to by a UIP if they indicate agreement with 201. As people submit new digital content, premises may also be applied to their new creation to provide context to their content or to provide strength to their arguments (refer, e.g., to FIG. 4). A Premise Context is a term used to describe the context of a UIDW and is determined by the list of Premise UIDWs for that UIDW. In order for two UIDWs to share a premise context, they must: (1) Have the same number of premises; (2) If they have premises, the first premise of each UIDW must be the same; and (3) If they have more than one premise, the remaining list of premises after the first must consist of the same UIDWs, but the order doesn't matter.

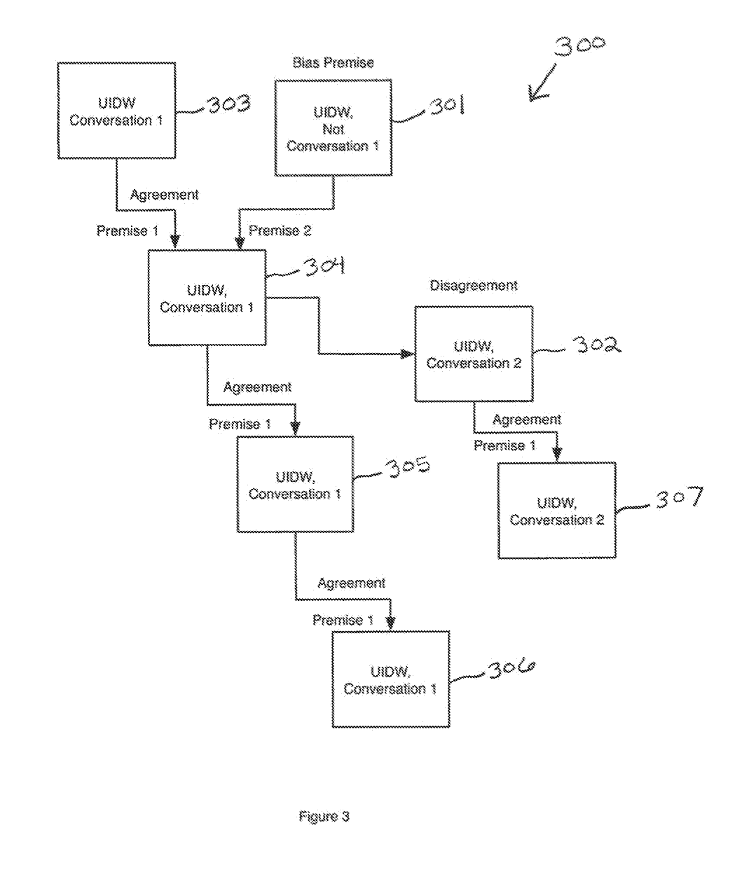

In FIG. 3, an illustration of a conversational thread 300 is shown according to an embodiment. In one embodiment, a conversation 300 can comprise a plurality of conversational paths (e.g., paths 310 and 311) as indicated by the arrowed lines, wherein each conversational path is formed by linking a plurality of UIDWs in succession with another. For example, UIDW 303 is the first work along conversational path 310 in conversational thread 300. As illustrated, people can continue on the same conversational path by agreeing with a previous work as the agreement between UIDWs 304, 305 and 306, which are all contained in the same conversational path 310 as 303, and by providing their own work to supplement the previous work. Additionally, each new work may include premises from other conversational threads as shown by premise of UIDW 301. Also, at any time a person may disagree with what is said, and they may branch off on another conversational thread thereon, as shown by the disagreement between UIDW 302 and 304. Subsequent agreements with a disagreement, such as UIDW 307 with 302, occur on the conversation path of that particular UIDW (e.g., conversational path 311 of UIDW 302).

In embodiments, each UIDW created with an attitudinal relationship to a previous UIDW is called an Agreement UIDW or a Disagreement UIDW. For example, each of 304, 305, 306 and 307 are called Agreement UIDW, which is created by a UIP in response to a previously created UIDW (created by any UIP), and becomes part of the same conversational thread as the previously created UIDW. In addition, the previously created UIDW becomes the first premise of the new UIDW, which implies that the UIP is in agreement with the premise at the time they post the new, Agreement UIDW. A disagreement, however, is represented by a Disagreement UIDW as in UIDW 302. A Disagreement UIDW generally refers to a UIDW that is created by a UIP in response to a previously created UIDW (created by any UIP), and whereby the UIP creator disagrees with the previously created UIDW at the time they post the new, Disagreement UIDW.

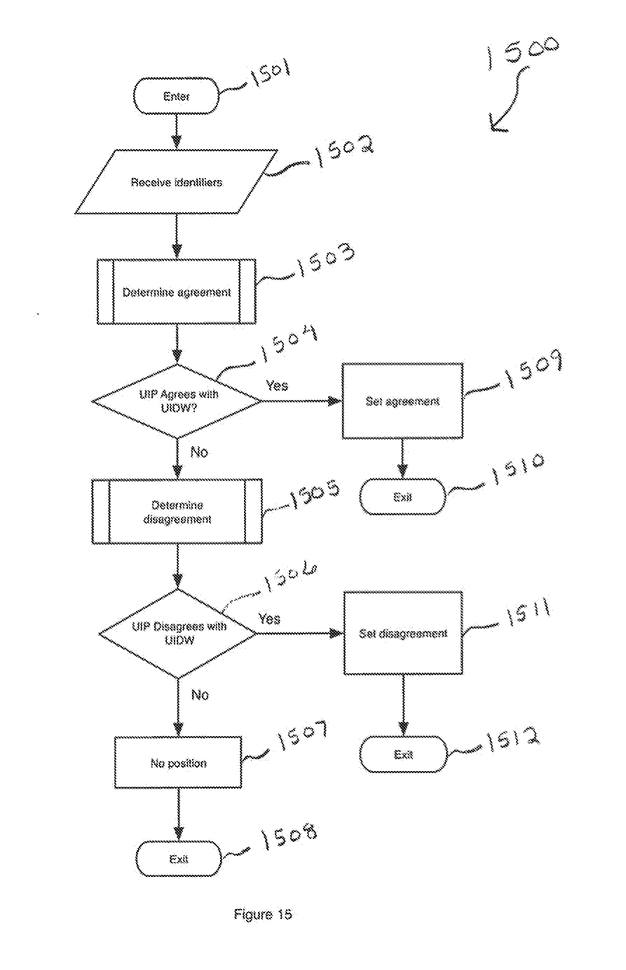

FIG. 4 depicts a method 400 for determining an indirection level for a UIDW according to an embodiment. FIG. 4 illustrates how a disagreement with a premise might cause a calculated disagreement (i.e., an indirection level) to be determined for any particular work utilizing method 400. As previously discussed, a disagreement is represented by a Disagreement UIDW such as 401 and 402, whereby the UIP of each work 401 and 402 disagrees with the previously created UIDW 408 and UIDW 409. In general, each UIP by default has no position on each UIDW created by other UIPs (i.e., the UIP neither agrees nor disagrees with it). A UIP may, however, take one of 2 positions on a UIDW, either directly by indicating agreement or disagreement with it, or indirectly by indicating disagreement with one of its premises or by indicating agreement with another UIDW for which it is a premise. The position of each UIP for a particular UIDW is determined at run time based upon premise logic as shown in FIG. 15. The result, either agree, disagree or no position, is considered to be a UIP Position for a UIDW.

For example, if a user disagrees with a premise of a work (e.g., UIP creator of UIDW 402 disagrees with premise 409 of UIDW 407) as UIDW 402 was created, then the user implicitly disagrees with all of the works that use 409 as a premise (i.e., UIP creator of UIDW 402 implicitly disagrees with UIDW 407, 404 and 403). Based upon how deep the disagreement is within the premise tree of the work, a level of indirection can be calculated. In other words, the minimum number of branches through a premise tree that are required to find the UIP position for a particular UIDW is called the Indirection Level for that position. For instance, if a UIP Position is determined to be Agree based upon agreement with a premise of a premise of the UIDW in question, the indirection level is 2. Similarly, if a UIP position is determined to be Disagree based upon a disagreement with the premise of a premise of the UIDW in question, as in 401 with 408 and 405, the indirection level is 2. Although, as discussed above, the indirection level increases as the number of branches increase. For example, the indirection level for disagreement with UIDW 403 caused by UIDW 402 is 3 where UIDW 402 is in direct disagreement with premise 409, which appears 3 levels deep in the premise tree of 403. In addition, if the UIP directly agrees or disagrees with the UIDW in question, the indirection level is 0. Disagreement with premises higher in the premise tree of a work indicates stronger disagreement than a disagreement at lower levels of the premise tree of said work, e.g., the disagreement of 401 with UIDW 408 provides a stronger disagreement with UIDW 403 than the disagreement of 402 with UIDW 409.

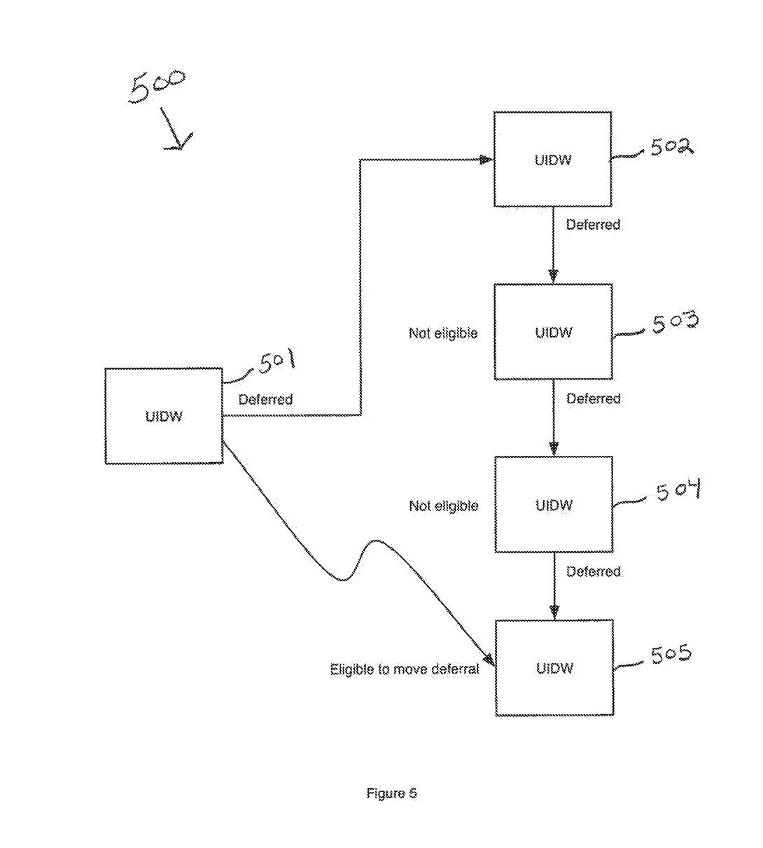

FIG. 5 depicts a flow diagram of a deferral chain 500 according to an embodiment. In a deferral chain, such a chain 500, any person can defer any of their works to another work if someone else has suggested it, as indicated by 501 deferred to 502, 502 deferred to 503, 503 deferred to 504, and 504 deferred to 505. Once a work is deferred, it might be further deferred at any time, but only to the end of a chain of deferral, as indicated in this figure. For example, 501 may be further deferred to 505 but not 504 or 503 because they are not at the end of deferral chain 500. By holding to these rules, it is guaranteed that deferrals will always result in a reduced set of representative works, such that continuous progress can be made in combining similar attitudes and digital content, to facilitate better communication over a shared understanding of an issue.

FIG. 6 is an exemplary tabular depiction of metadata fields that can be used to create each UIDW according to an embodiment. Each field has a purpose in some embodiment of the present invention, but not all are required for the present invention. These fields provide for connecting the digital content into the premise trees described above and all other semantic relationships between digital works described above and hereafter.

In the table of FIG. 6, the terms work or works refers to a Uniquely Identifiable Digital Work (UIDW) or Uniquely Identifiable Digital Works (UIDWs), and the list uses an identifying reference for each entry in the list. For example, 601 lists all premises of the UIDW by unique identifier. 602 lists all UIDWs that contain the UIDW as a premise, by identifier. 603 lists all UIDWs that form a disagreement relationship with the UIDW, each listed by identifier, each carrying an identifier pointing back in the Disagreement Parent field 604. 605 can optionally reference the identifier of a UIDW to which it is deferred, and 606 contains a list of identifiers for UIDWs that are deferred to this UIDW. 607 is a flag that when set, indicates the UIDW has been retracted by its creator due to a new attitude that contradicted it. 608 is a counter used to track the number of times a UIDW is used as a bias in conversation. 609 is a flag that indicates when a disagreement UIDW is a repeated disagreement to the same UIDW, and is thus marked as a reiteration. 610 is an identifier that can be duplicated in all UIDWs of the same conversational thread to allow grouping UIDWs as such. 611 is a list of identifiers for Uniquely Identifiable Persons who agree with the UIDW but do not wish to say why, or in other words, they have posted an attitudinal agreement request without a new UIDW attached. 612 is a field that contains the identifier of the Uniquely Identifiable Person that created the content and posted it to the server as a new UIDW.

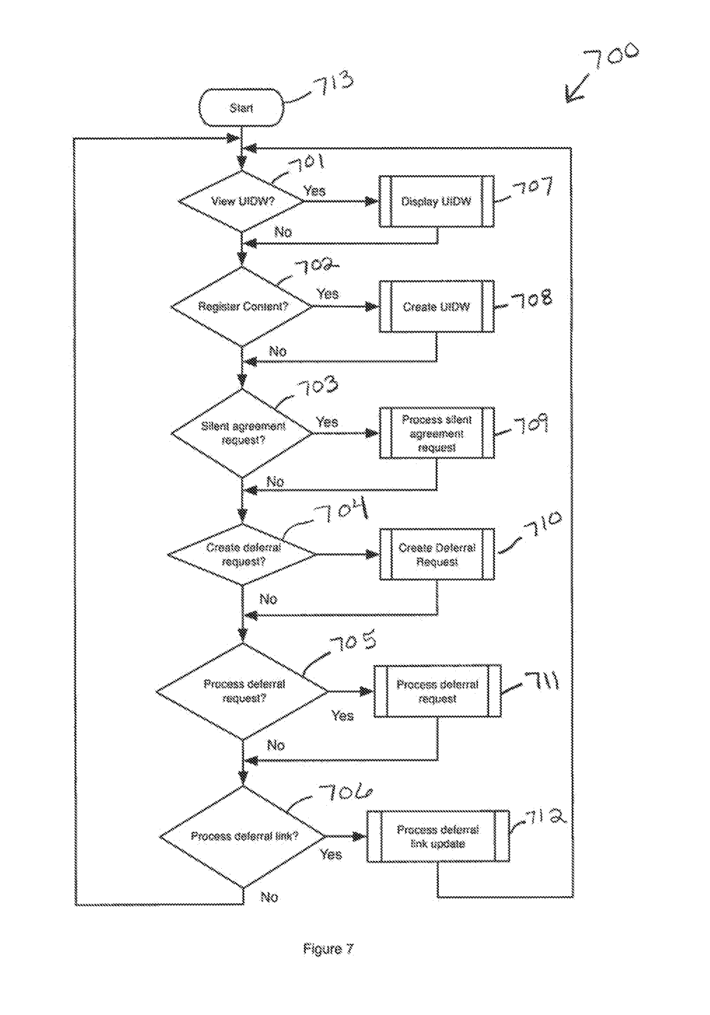

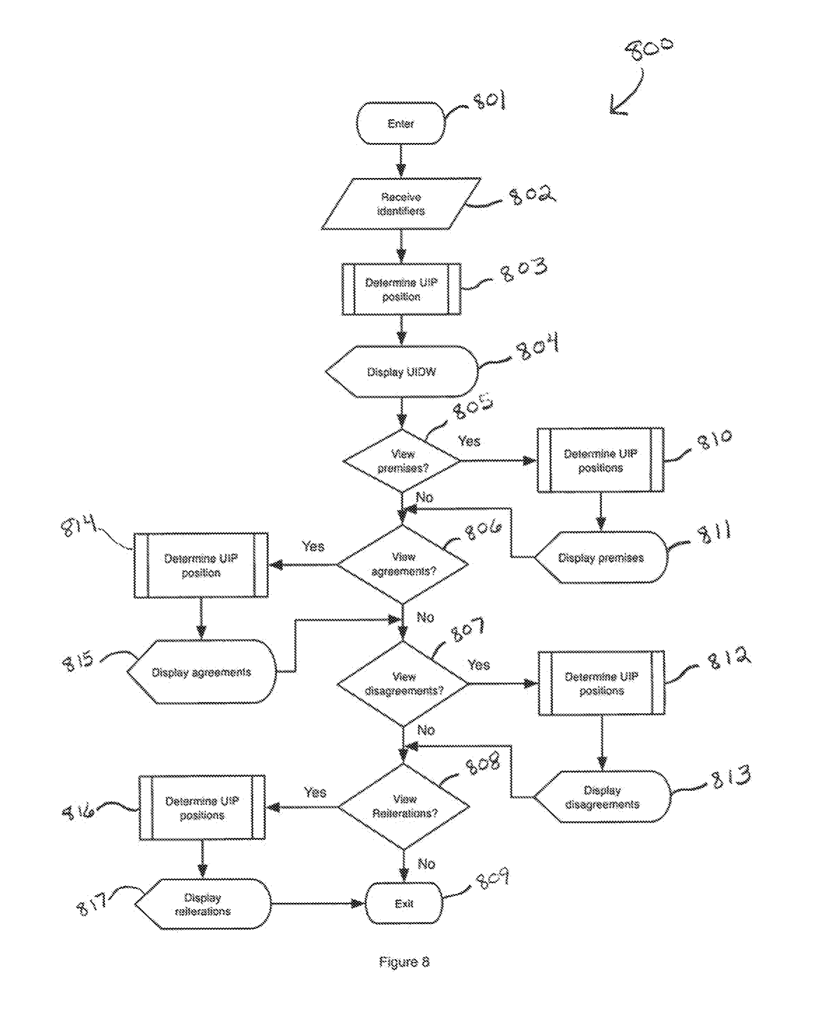

FIG. 7 depicts a flowchart of a method for executing a main process 700 according to an embodiment. In FIG. 7, each of 701, 702, 703, 704, 705, and 706 check for the kind of request submitted by a UIP and each of 707, 708, 709, 710, 711, and 712 are steps that dispatch the request to the processes in FIGS. 8, 9, 18, 19, 20, and 22 respectively.

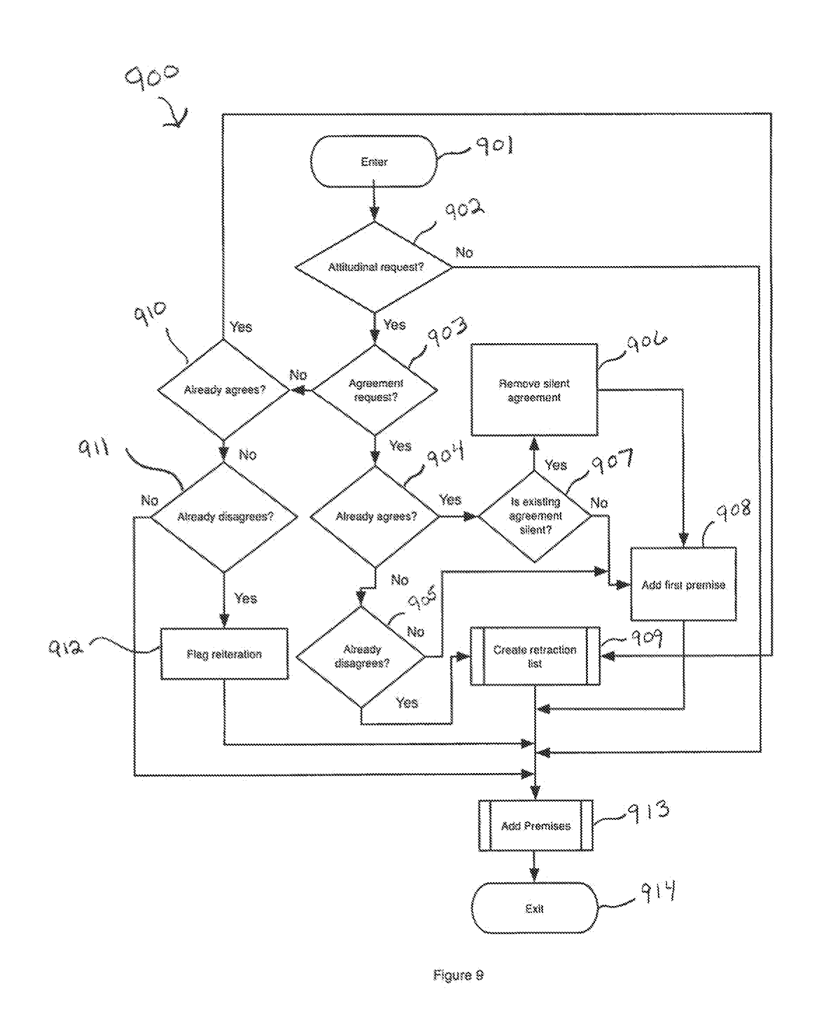

As depicted, main process 700 is initiated at 713 and a first request is submitted by a UIP. At 701, the first request, e.g., View UIDW is verified and dispatched to a Display UIDW subroutine 800 at 707, which will be discussed in further detail with reference to FIG. 8. Next at 702, a second request to register content as UIDW is submitted. Upon verification at 708, the second request is dispatched to a Create UIDW subroutine 900 (refer, e.g., to FIG. 9). As previously discussed, subsequent requests (e.g., silent agreement, process deferral, process deferral links) can be submitted by a UIP and verified to determine which corresponding process should be executed (e.g., 708, 709, 710, etc.). Some embodiments might be event-driven, while others might be driven by a continuous loop as described herein. For example, in an event-driven manner, main process 700 can respond to events and requests posted by UIPs. The functions are the same regardless, and so a continuous loop is described here to fully explain the process. Within each flowchart, calls to subroutines are indicated by a predefined process structure such as 707-712, where “Predefined Process” refers to a figure title in subsequent flowchart figures (e.g., Display UIDW, Create UIDW, etc.).

FIG. 8 depicts a flow diagram of a Display UIDW subroutine 800 process for displaying a UIDW to a person from any UIP's perspective according to an embodiment. At 801, process 800 is initiated and an UIP and UIDW identifier is received at 802. At 803, a UIP position subroutine 1500 of FIG. 15 is called to find agreements, disagreements, or no position for the UIP for whom the perspective is being viewed. The UIDW is displayed at 804 along with the position and indirection level of that position using any of many possible visual cues to indicate the indirection level. Next at 805-808, various UIP requests are submitted. For example, a View Premises request is sent at 805. If a person whishes to view the premises of the UIDW under examination, 810 calls the UIP position subroutine 1500 of FIG. 15 is called for each premise in the tree, and the tree structure with position information is displayed at 811.

This process is repeated for each of the remaining requests at 806 (View Agreements), 807 (View Disagreements) and 808 (View Reiterations), such that the UIP position subroutine 1500 is called at each of 814, 812 and 816. At 814, 812, and 816, subroutine 1500 is called for each list of UIDWs described within the metadata of the UIDW, and the list and the positions respectively to the viewing UIP are displayed at 815, 813, and 817.

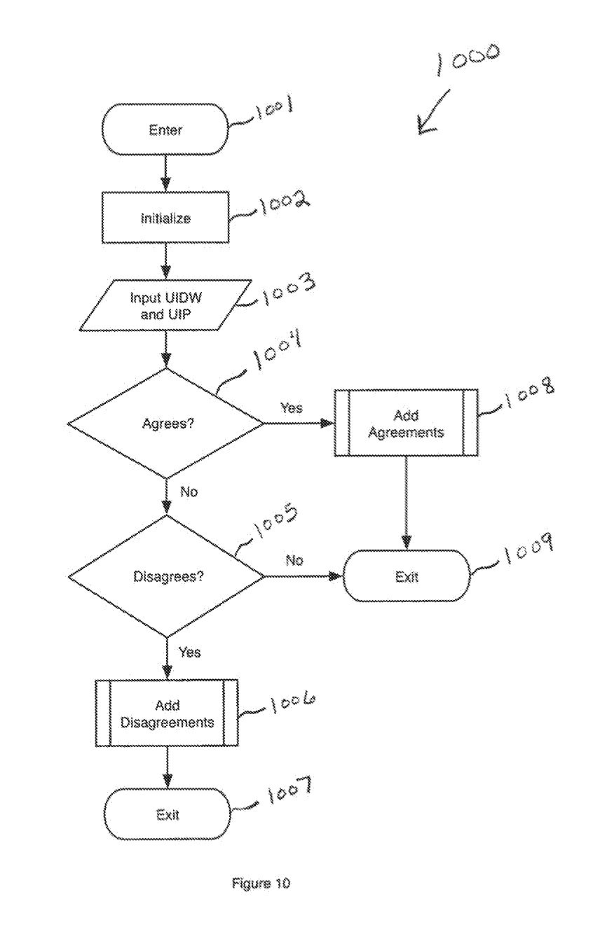

FIG. 9 depicts a flow diagram of a create UIDW subroutine 900, according to an embodiment. Subroutine 900 is initiated at 901. At 902 a determination is made as to whether the work is being created without connection to an attitude towards an existing UIDW, i.e., whether it starts a conversational thread or is in response to an existing Target UIDW within an existing conversational thread. If the work is in connection with an attitude upon an existing UIDW, then checks for contradiction with previous attitudes for the target UIDW are made at 905 and 910 and checks for a repeated, consistent attitudes towards the target UIDW are made at 904 and 911. All previous attitudes towards the target UIDW used in 904, 905, 910 and 911 are determined by calling a UIP position subroutine 1500. If contradiction is detected at 905 or 910, a contradiction list subroutine 1000 as illustrated in FIG. 10 is called, which is executed anytime a contradiction is created between a new UIDW and the existing attitudinal positions towards other UIDWs. 911, which is reached only if the UIDW is attached to an attitudinal disagreement with a target UIDW, checks for previous consistent disagreements with the same target UIDW by calling subroutine 1500, and if such previous disagreements are found, the new UIDW is flagged as a reiteration of that disagreement in 912. 904, which is reached only if the UIDW is attached to an attitudinal agreement with a target UIDW, checks for previous consistent agreements by this UIP with the same target UIDW by calling subroutine 1500. If such previous agreements exist, 907 checks whether that previous agreement was silent or whether it was attached to a UIDW. If only 1 previous agreement by this UIP exists and it is a silent agreement, it is removed when the new UIDW is later stored in 1400, which removes the redundant agreement. For all attitudinal agreement UIDW requests, the target UIDW is added as the first premise of the new UIDW in 908.

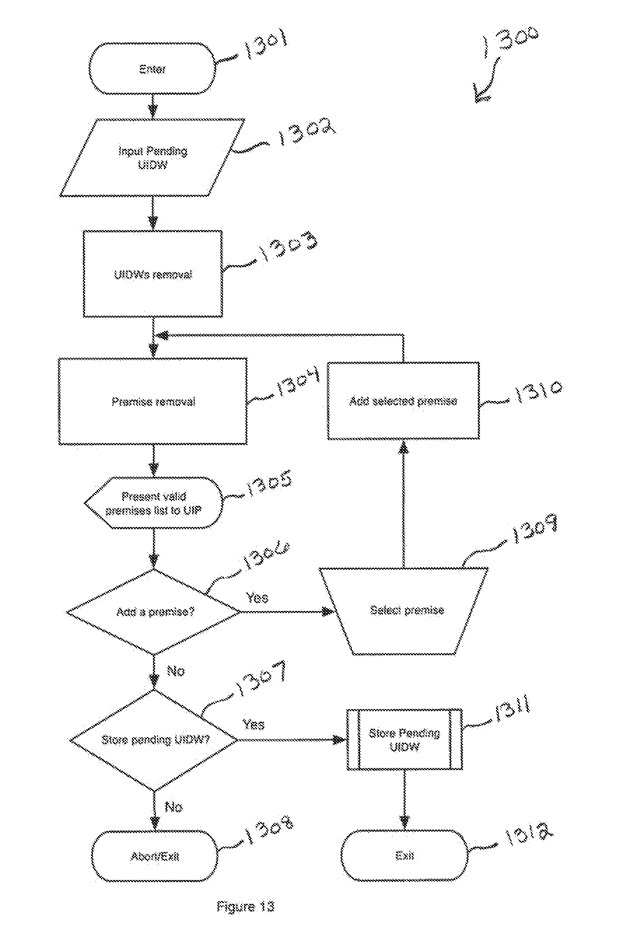

At 913, a premise addition subroutine 1300 (refer, e.g., to FIG. 13) is called for every new UIDW, which provides the opportunity for adding premises to the UIDW from a list of existing UIDWs.

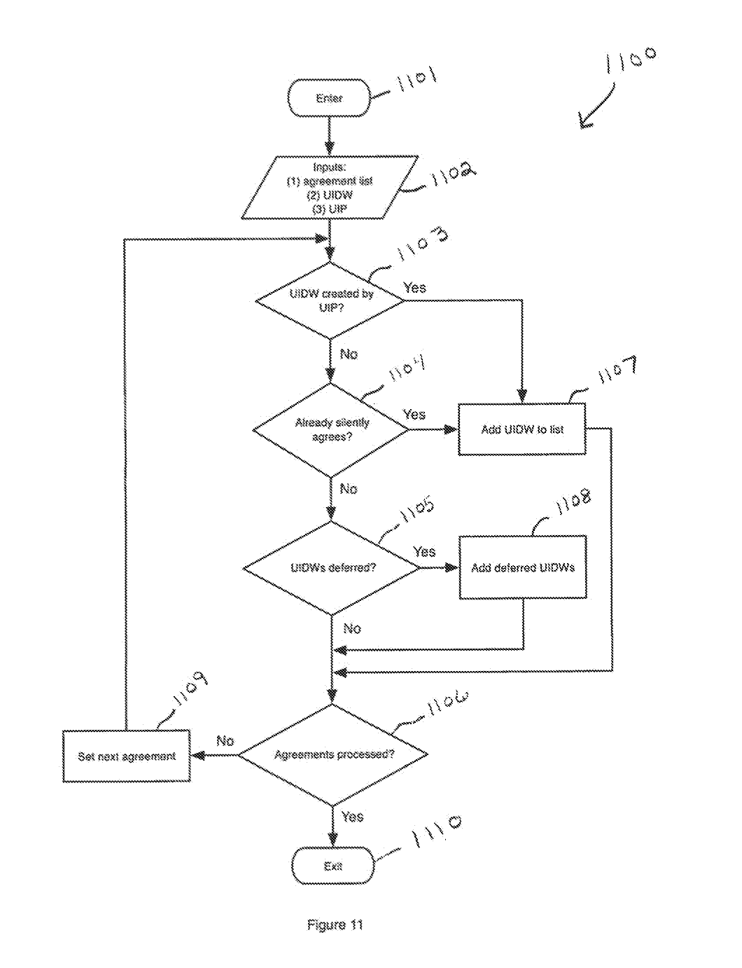

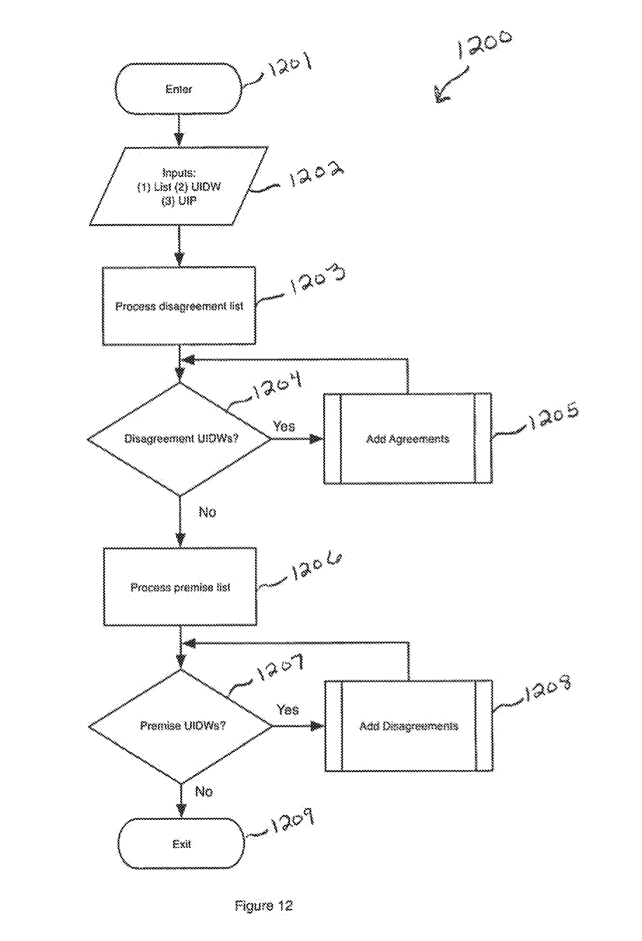

Referring to FIG. 10, a flow diagram of a contradiction list subroutine 1000 is shown which is called any time a new attitudinal request or the creation of a new UIDW creates a contradiction with existing attitudes by the same UIP or other UIDWs created by the same UIP. Subroutine 1000 creates a list of items, including attitudinal indicators and UIDWs that must be retracted for a particular request to complete. At 1001, contradiction subroutine is initiated and a retraction list is initialized at 1002, thereby allowing subroutine 1000 to input a UIDW and UIP at 1003. At 1004 and 1005, a determination is made as to whether the UIP is currently in agreement or disagreement with the UIDW by calling subroutine 1500. If the UIP currently agrees with the UIDW, then at 1008 an agreement list subroutine 1100 (refer, e.g., to FIG. 11) is called to find agreements that conflict with the new attitudinal request. However, if a disagreement currently exists for the UIP upon the UIDW, then at 1006, a disagreement subroutine 1200 as discussed with reference to FIG. 12 is called to find disagreements that conflict with the new attitudinal request. Upon execution and completion of subroutine 1100 or 1200, contradiction subroutine 1000 is exited at 1007 or 1009.

As described above, FIG. 11 is a flow diagram of an agreement list subroutine 1100 that is called to find all agreements by a UIP that conflict with a new request by that same UIP, according to an embodiment. 1104 adds a found silent agreement to the list of retractions and 1105 adds all UIDWs deferred to the contradictory UIDW to the list. As illustrated, subroutine 1100 is initiated at 1101 and an input list is created at 1102. At 1103-1105 a sequence of decisions are made to determine whether or not to add a UIDW to the list or to add all UIDWs deferred to the UIDW to the list. For example, at 1103 and 1104, if a UIDW was created by the UIP or if a silent agreement exists for the UIP on the UIDW, the UIDW is added to the list of retractions at 1107. In the event that neither the UIP is the creator of the UIDW nor a silent agreement exists by this UIP upon this UIDW, subroutine 1100 verifies whether or not the UIP has deferred any of their UIDWs to the UIDW at 1105. If such deferrals exist, subroutine 1100 adds all UIDWs deferred to the contradictory UIDW to the list at 1108. At 1106, subroutine 1100 continuously repeats steps 1103-1105 for every agreement in the Agreements list of the metadata of the UIDW under examination and sets the next agreement as an input of the UIDW at 1109. Once all agreements have been processed, subroutine 1100 is exited at 1110.

As described above, FIG. 12 depicts a flow diagram of a disagreement list subroutine 1200 that is called to find disagreements that conflict with a new request. This Subroutine 1200 is an iterative process, with 1204 iterating over all Disagreements in the metadata of the UIDW, and 1205 calling into the subroutine 1100 of FIG. 11 for each such Disagreement.

As illustrated, subroutine 1200 is initiated at 1201 any time a disagreement conflicts with a new request and inputs a new or existing list of contradictions 1202. Next at 1203, processing of the disagreement list in the UIDW metadata begins and is iteratively checked at 1204 to verify whether or not any disagreement UIDWs remain in the list. For each disagreement in the UIDW metadata list, subroutine 1100 is called at 1205, passing in the UIDW from the disagreement list and the list of conflicts so 1100 can add UIDWs to the list. All agreements found in 1100 are considered additional disagreements with the new request (an agreement with a disagreement is considered an disagreement) and are added to the list. Otherwise, if no disagreements remain in the UIDW's metadata list of disagreements, processing of the Premise List in UIDW metadata begins at 1206. At 1207, subroutine 1200 iterates over all Premises in the metadata of the UIDW and at 1208 calls recursively into itself for each premise of the input UIDW. Once the premise list and all nested premise lists have been processed, subroutine 1200 is exited at 1209.

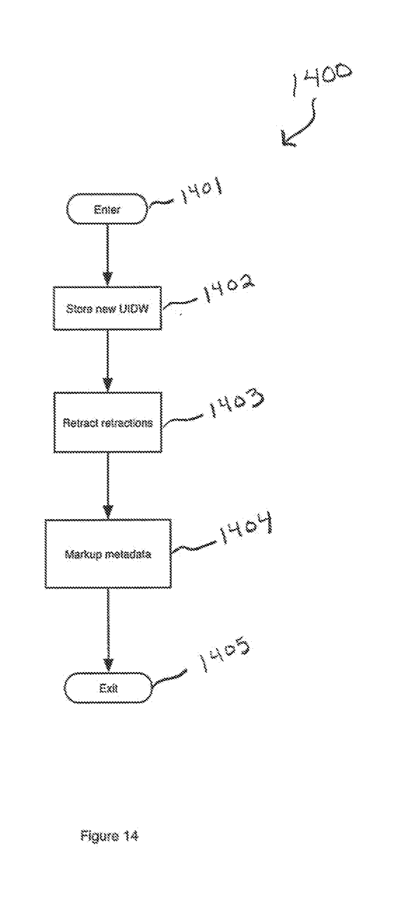

FIG. 13 is an add premise subroutine 1300 that shows a process for determining which premises are valid for attaching to a new UIDW. At 1301, premise subroutine 1300 is initiated, which determines what premises are valid for attaching to a new UIDW. At 1302, a valid premise list is generated utilizing all existing UIDWs. Next at 1303, all UIDWs with which the UIP disagrees are removed from the valid premises list. In addition, at 1304, each premise attached to the pending UIDW is removed and all corresponding premises in its premise tree are removed from the valid premises list. Upon completion, the valid premises list is updated and presented to the UIP at 1305. Next at 1306, the UIP is asked if they wish to add a premise from a list of valid premises. If a premise is to be added, then at 1309, the user (i.e., UIP) that created the pending UIDW selects a premise from the list of valid premises. At 1310, the selected premise is added to a pending UIDW's metadata, and steps 1304-1310 are repeated for each added premise. After all premises are added as the UIP wishes, at 1307, the UIP is asked whether the pending UIDW should be stored. If it is to be stored, a storage subroutine 1400 (refer, e.g., to FIG. 14) is called to store the pending UIDW at 1311. At 1312, subroutine 1300 is existed once the pending UIDW has been stored; however, if no UIDW is stored, subroutine 1300 is aborted at 1308.

FIG. 14 depicts a flow diagram of a storage subroutine 1400 that shows steps necessary to store a new UIDW. At 1402, a new UIDW is stored subsequent to an initiation of subroutine 1400 at 1401. In some embodiments, an exact copy of the submitted digital content as part of the UIDW may be stored, while others may only store a unique identifier as a hash value created over the digital content to uniquely identify it, and to be returned to the requestor. The embodiment discussed herein will do either upon request, i.e., the requestor can ask that the content be stored in full or that it only be stored in hashed form. Next at 1403 all conflicting UIDWs found in an earlier step as retracted are marked as such, and also any silent agreements that might conflict with the new UIDW are removed. At 1404 the metadata of all premises of the UIDW are marked, and the metadata of the attitudinal target, if this UIDW was created as part of an attitudinal request. Upon completion of step 1404, subroutine 1400 is exited at 1405. In FIGS. 15-17, a process that comprises Premise Logic is shown. As discussed herein, premise logic is a process of determining direct or implied positions on each UIDW given the following set of logical requirements: (1) A UIP cannot both agree and disagree with the same UIDW; (2) If a UIP directly agrees with a UIDW, they agree with every premise of that UIDW and every premise of every premise and so on. This can form premise a tree of substantial size with all UIDWs in that premise tree carrying an implicit agreement by the UIP; (3) If a UIP disagrees with a UIDW, they also disagree with every UIDW containing it in its premise list, and iteratively every UIDW premise in its premise list, potentially forming a large tree of UIDWs with which the UIP implicitly disagrees.

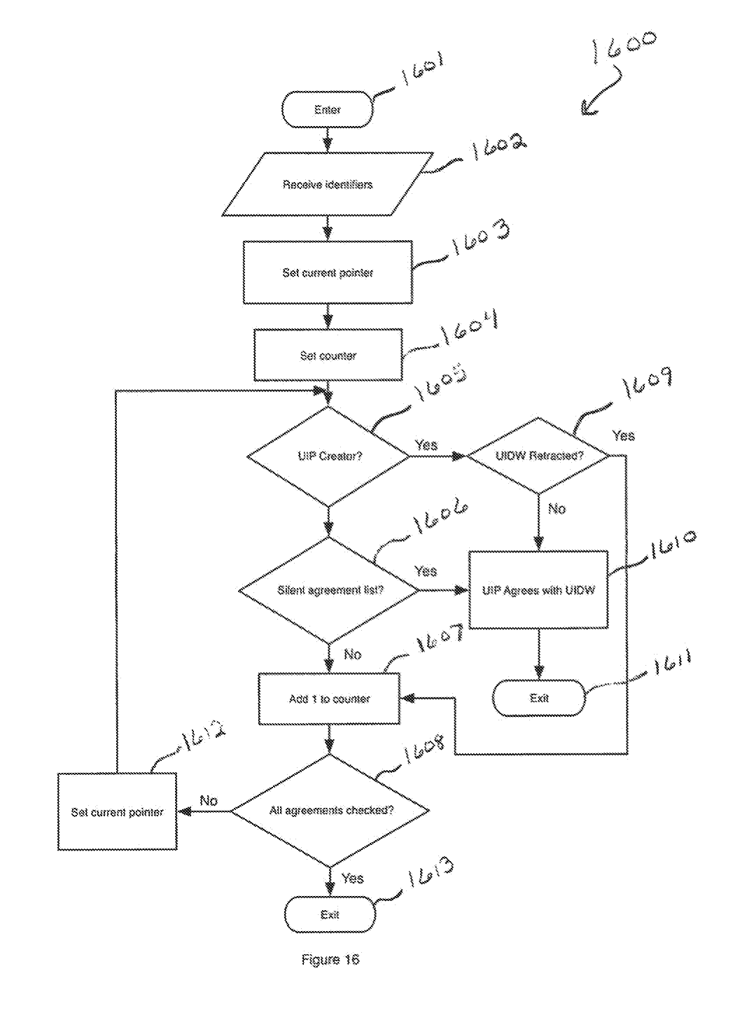

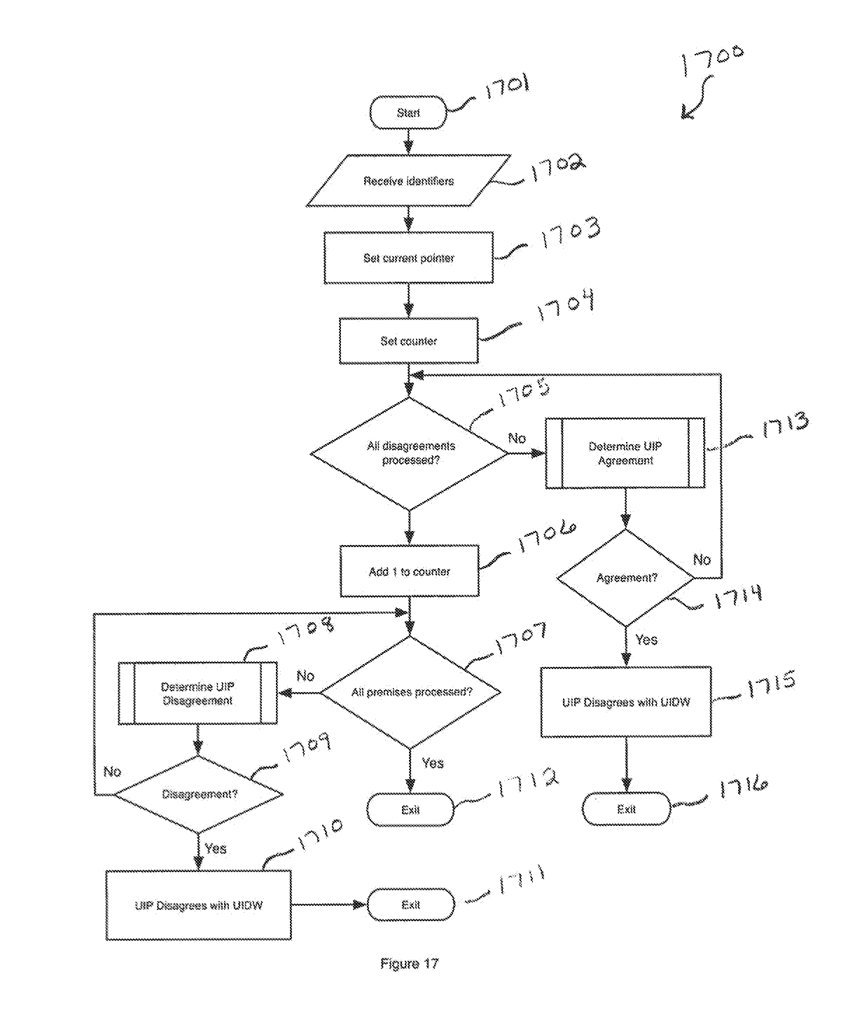

In FIG. 15, a flow diagram of a UIP position subroutine 1500 is shown. In embodiments, subroutine 1500 is used to calculate the attitudinal position and the indirection level of that position for any UIDW stored in the system for any UIP. Subsequent to initiation of subroutine 1500 at 1501, an identifier is received for a single UIDW and a single UIP at 1502. Next at 1503 a UIP agreement subroutine 1600 (refer, e.g., to FIG. 16) is called, which finds agreements by this UIP with the UIDW. If agreements are found, the agreement closest to the UIDW in the premise tree indicates the indirection level of the agreement, and this is recorded at 1509. Otherwise, if no agreements are found at 1504, a UIP disagreement subroutine 1700 of FIG. 17 is called at 1505 to find disagreements by the UIP with the UIDW and the indirection level of the closest such disagreement within the premise tree.

At 1506, a determination is made based upon the results of 1700 as to whether a disagreement exists, and if a disagreement is present, it is recorded at 1511 as a disagreement with the indirection level returned, and subroutine 1500 is exited at 1512. If no agreements or disagreements are found, the position of the UIP with regard to the UIDW is calculated and reported as No Position at 1507, and subroutine 1500 is exited at 1508.

As described above, FIG. 16 depicts a flow diagram of a UIP agreement subroutine 1600. As depicted, subroutine 1600 is a process for determining agreements by a UIP with a particular UIDW. At 1601, UIP agreement subroutine 1600 is initiated, and similar to subroutine 1500, an identifier for a UIDW and UIP is received at 1602. Next at 1603, a current UIDW pointer is set to the UIDW represented by the identifier. Additionally, at 1604, an agreement indirection counter is set to zero to reset the counter to determine an indirection level. Subroutine 1600 begins by checking for agreements with the UIDW and then iterates over the agreement tree of the UIDW in question, looking for nested agreement works at 1608, silent agreements at 1606, or works that agree by creation at 1605, such that each iteration increments the indirection counter by one. At 1605, subroutine 1600 verifies if the UIP is the creator of the current UIDW. If the UIP is the creator, the UIP is determined to agree with the UIDW at 1610 and the indirection level is equal to the indirection counter if the UIDW is not determined to be retracted at 1609. In other words, agreement by creation exists when a UIDW is created by the UIP and is not refracted. The UIP implicitly agrees with any such work created by them until it is otherwise retracted. Likewise, at 1606 if a silent agreement exists by the UIP upon the UIDW, the indirection counter is again set equal to the indirection level of the UIDW at 1610. If neither a silent agreement exists nor the UIP has created and not refracted the UIDW, the agreement indirection counter is incremented by one at 1607. As stated above, subroutine 1600 continuously iterates over the agreement tree at 1608, each time setting the current UIDW pointer to the next agreement UIDW at 1612 until all agreements are processed. Upon execution of each request, subroutine 1600 is exited at 1611 or 1613.

FIG. 17 depicts a flow diagram of a UIP disagreement subroutine 1700 that shows a process for finding disagreements by a UIP with a UIDW. Similar to subroutine 1600, subroutine 1700 is initiated at 1701 and a UIDW and UIP identifier is received at 1702. Next at 1703, a current UIDW pointer is set to the UIDW represented by the identifier. At 1705, subroutine 1700 searches the disagreement list of the UIDW for any disagreement works created by the UIP or agreements with such at 1713 by calling into subroutine 1600. Subroutine 1700 checks the results of subroutine 1600 for agreements with the disagreement UIDW at 1714. If an agreement was found, the indirection level is returned at 1715, which is equivalent to the count of the disagreement indirection counter, and subroutine 1700 is exited at 1716. If no agreement was found in 1600, the next disagreement is processed at 1705.

After all disagreements with the UIDW have been processed at 1705, 1713, and 1714, the disagreement indirection counter is incremented by one at 1706. Next at 1707, it is determined whether or not each premise of the UIDW of the current UIDW has been processed. If each has been processed, then subroutine 1700 is exited at 1712. Contrarily, if each has not been processed then subroutine 1700 is called again to determine if a UIP disagreement with the next premise of the UIDW can be found at 1708. If no disagreement is found there, it continues iterating over the premise list of the UIDW 1707 and calls the current subroutine (i.e., subroutine 1700) for each premise of the premise list of the UIDW in question at 1709. If a disagreement is found, then at 1710 it is returned along with the indirection level of the premise of the UIDW wherein the disagreement was found, and subroutine 1700 is exited at 1711. The recursive calling of 1700 for each premise in the list of premises of the UIDW may result in a complete traversal of the premise tree of the UIDW, each call searching for disagreements with a premise in the premise tree.

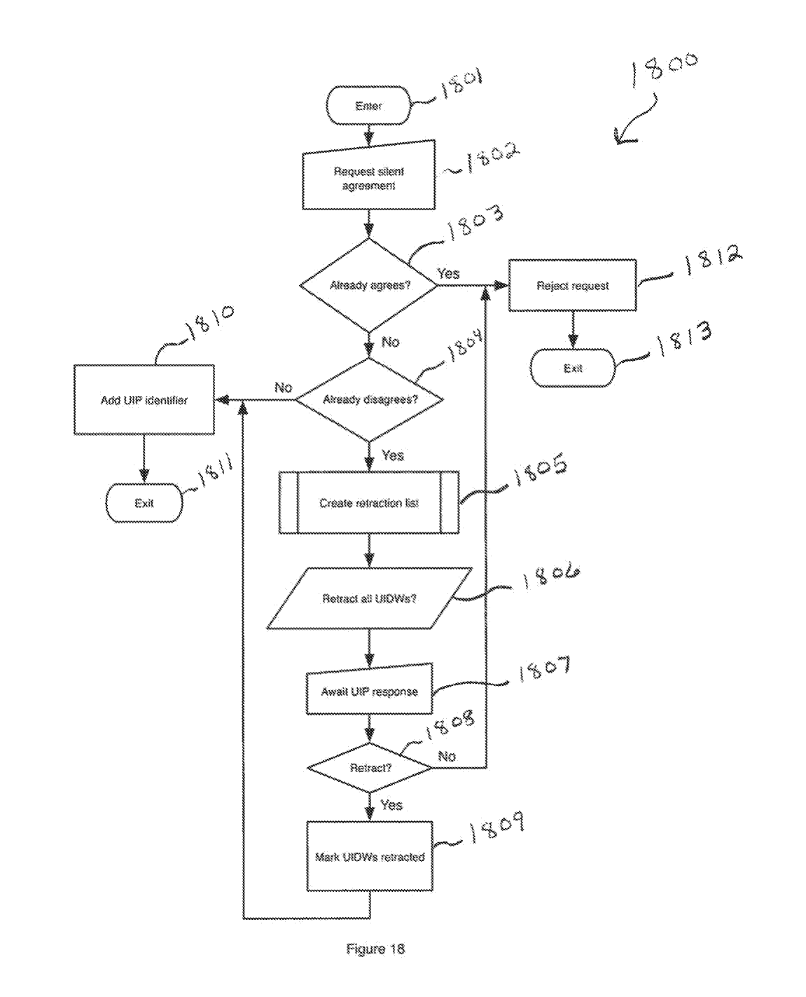

FIG. 18 depicts a flow diagram of a silent agreement request subroutine 1800 that shows a process a server (e.g., server 101 as discussed with reference to FIG. 1) uses to handle an attitudinal request from a UIP in which the UIP indicates agreement with a target UIDW without providing additional content for creating a new UIDW. The request is recorded in this figure as a Silent Agreement as defined here: A UIP may take a position of agreeing with an existing UIDW without posting a new UIDW in response. This is called a silent agreement. If the user subsequently agrees with the UIDW by using it as a premise, the silent agreement is removed in lieu of the new Agreement UIDW.

In FIG. 18, subroutine 1800 is initiated at 1801 and a UIP requests a silent agreement with a UIDW at 1802. At 1803, a determination is made to verify if an agreement already exists by the UIP with the UIDW by calling subroutine 1500. If an agreement exists, the request is rejected at 1812 and subroutine 1800 is exited at 1813. Otherwise if no agreement is present, then at 1804 subroutine 1800 verifies whether or not a disagreement exists by the UIP with the UIDW by calling subroutine 1500. If no disagreements exist, the UIP's identifier is added to the silent agreement list for the UIDW at 1810 and subroutine 1800 is exited at 1811. Contrarily, if a disagreement exists, a list of retractions is created that is required to eliminate contradictions with the UIDW at 1805 by calling contradiction subroutine 1000. Once a retraction list is created, subroutine 1800 determines if the UIP wants to retract all UIDWs in the retraction list at 1806. At 1807, subroutine 1800 awaits a response and based on the response determines whether or not to retract the UIDWs at 1808. If there is no retraction, the request is rejected at 1812 and subroutine 1800 is exited at 1813. However, if a refraction is requested, then each UIDW in the retraction list is marked as refracted at 1809 and the UIP's identifier is added to the silent agreement list for the UIDW at 1810. After the identifiers have been added, subroutine 1800 is exited at 1811.

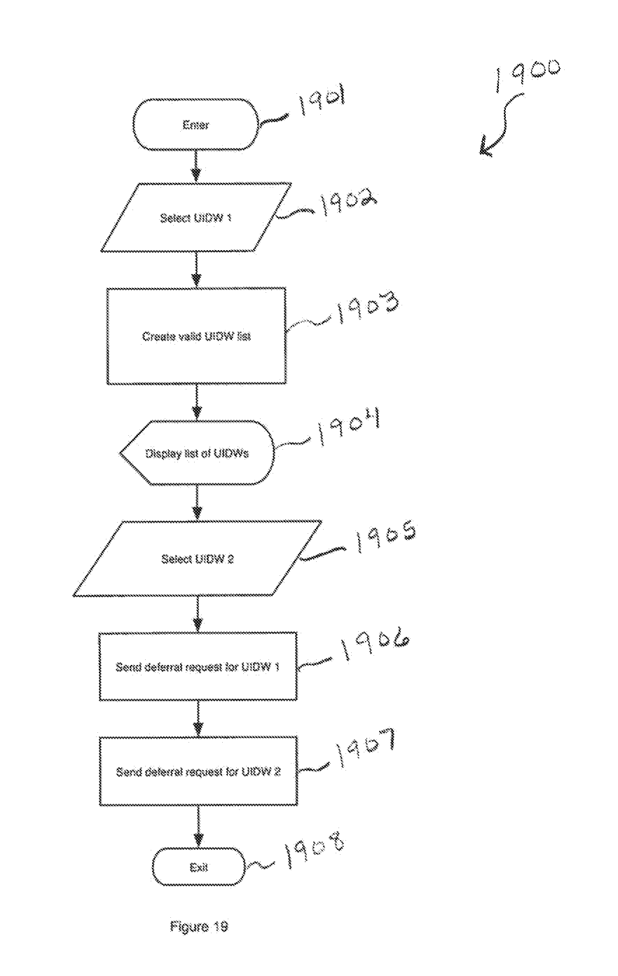

FIG. 19, depicts a flow diagram of a deferral request subroutine 1900. Subroutine 1900 shows a process that some embodiments use to allow a UIP to create a Deferral Request as defined here: A request from a third-party UIP for 2 UIPs to consider merging a UIDW created by each of them into one UIDW. A deferral request can only be made if the two target UIDWs: (1) are created by different UIPs, and neither of them is the UIP requesting the deferral; (2) contain identical lists of premises]; (3) are part of the same conversational thread and 4) Neither of the UIDWs have been retracted.

To begin creation of a deferral request, subroutine 1900 is initiated at 1901 and a UIP selects a UIDW (“UIDW 1”) at 1902. At 1903, a list of valid UIDWs in the same premise context as the UIDW is created and the list of the UIDWs is displayed to the UIP at 1904. Next at 1905, the UIP selects a UIDW from the list and it is labeled “UIDW 2.” A deferral request is then sent to the UIP creator of both UIDW 1 and UIDW 2 at 1906 and 1907, and subroutine 1900 is subsequently exited at 1908.

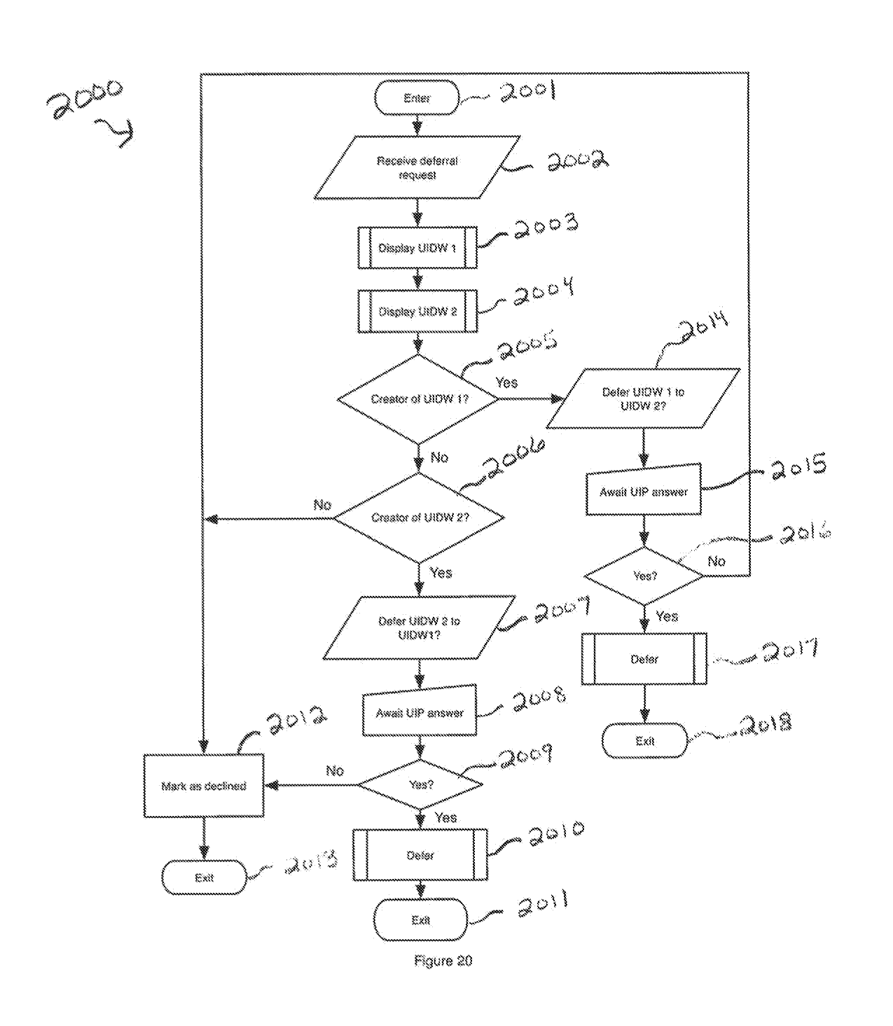

FIG. 20 depicts a flow diagram of a process deferral subroutine 2000 that illustrates a process for allowing a UIP to handle a deferral request from another UIP directed towards them. At 2001, subroutine 2000 is initiated and a UIP receives a deferral request with UIDW 1 and UIDW 2 at 2002. Next at 2003 and 2004, each UIDW (e.g., UIDW 1 and UIDW 2) is displayed that the requestor has suggested should be combined and represented as one UIDW. At 2005, a determination is made as to whether or not UIDW 1 was created by the UIP receiving the request. If UIDW 1 was not created by them, a subsequent is check is made to determine if UIDW 2 was created by them. If neither UIDW 1 nor UIDW 2 was created by the UIP, then at 2012 the deferral is marked as declined and subroutine 2000 is exited at 2013. Contrarily, if UIDW 1 or UIDW 2 was created by the UIP, then at 2014 or 2007 the UIP is asked if they wish to defer their UIDW to the other UIDW. For example, if UIDW 1 was created by the UIP, the UIP is asked if they wish to defer UIDW 1 to UIDW 2 at 2014, and likewise similar steps are repeated for UIDW 2 at 2007. In response, subroutine 2000 awaits an answer from the UIP at 2015 or 2008. If the UIP declines the referral at 2016 or 2009, the deferral is marked as declined at 2012 and subroutine 2000 is subsequently exited at 2013. Otherwise, if the UIP accepts the deferral request, then at 2017 or 2010, subroutine 2100 is called to perform the Deferral, as defined here: Upon being presented with a deferral request, which asks them to consider deferring one of their UIDWs to UIDW created by a different UIP, the UIP has the option of accepting the other UIP's UIDW as an acceptable representation of their own or rejecting it. The acceptance of the other UIDW as a representation of their own UIDW is called a deferral. A UIDW that has been deferred to another creates an agreement with the other UIDW and hides the original UIDW from other UIPs if possible. If other UIDWs are deferred to the original, the original will remain visible in certain circumstances, but will be hidden when doing so creates no ambiguity. Once a deferral has been made, subroutine 2000 is exited at either 2011 or 2018.

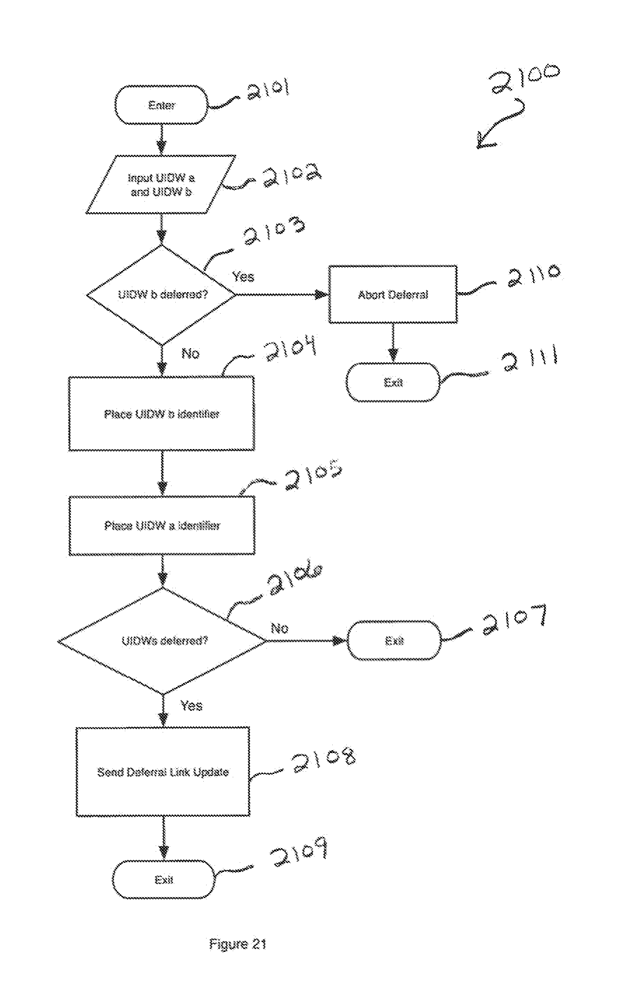

FIG. 21 depicts a flow diagram of a deferral subroutine 2100 that shows the detailed steps required to perform the deferral as discussed with reference FIG. 20. At 2101, subroutine 2100 is initiated and inputs two UIDWs, e.g., UIDWa, the UIDW to be deferred, and UIDWb, the UIDW to which UIDWa will be deferred at 2102. Next at 2103, the metadata of IUDWb is checked as to whether it is already deferred to another UIDW UIDWb If so, the deferral is aborted at 2110 and subroutine 2100 is exited at 2111. Contrarily, if UIDWb is not already deferred (e.g. it is at the end of a deferral chain), then at 2104 an identifier for UIDWb is placed in the metadata field of UIDWa: Deferred, and an identifier for UIDWa is placed in a metadata list of UIDWb: Deferred to this at 2105. At 2106, subroutine 2100 verifies if there are any UIDWs currently deferred to UIDWa, such that if no deferrals have been made subroutine 2100 is exited at 2107. Otherwise, if deferrals exist, at 2108, a notification is sent to each UIP that has a UIDW currently deferred to UIDWa as a Deferral Link Update Notification as defined here: If a UIDW has other UIDWs deferred to it and it subsequently is deferred to another UIDW, a notification is sent to each of the creators of the UIDWs deferred to it. This notification, called a Deferral Link Update notification, informs the each UIP of the deferral, and each UIP is given a chance to follow the new deferral by linking their UIDW to the end of the deferral chain of the new target of the deferral or leaving it as is. As deferred UIDWs are deferred to other UIDWs and so on, a chain of deferrals combines many UIDWs into a single representation. A UIP may optionally remove the deferral of their created UIDW at any time. Upon completion of the update at 2108, subroutine 2100 is exited at 2109.

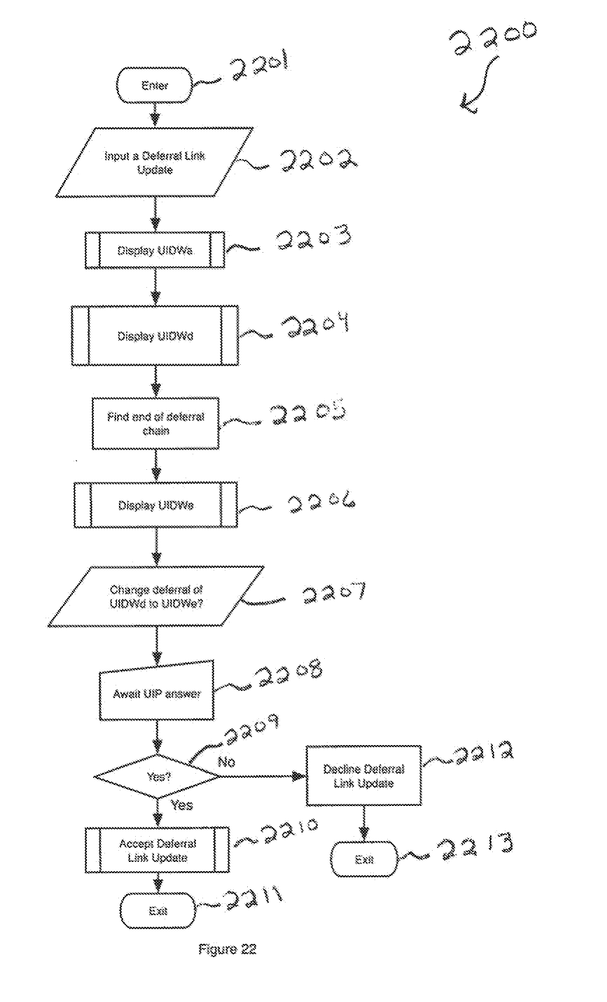

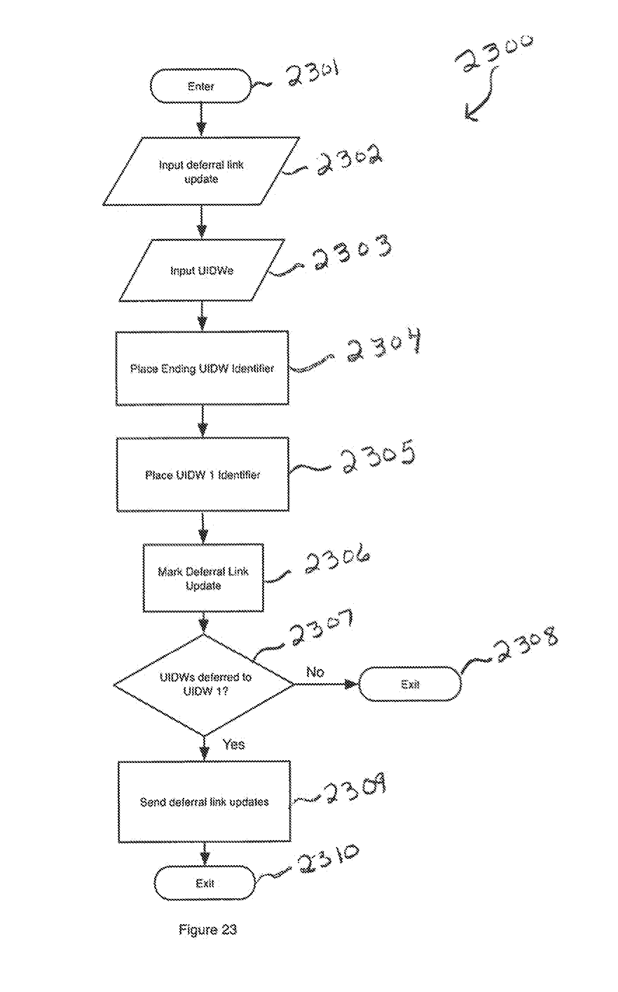

FIG. 22 depicts a deferral response subroutine 2200 that shows a process whereby a UIP may respond to a deferral link update notification as created in subroutine 2100. At 2201, subroutine 2200 is initiated and inputs a deferral link update notification for a UIP containing identifiers for 2 UIDWs: UIDWa as discussed with reference to FIG. 21 step 2108 and a UIDW which was already deferred to UIDWa at the time of its deferral in step 2108, herein referred to as UIDWd. Next at 2203 and 2204 subroutine 2200 displays the UIDWs represented in the request in question by calling into the view UIDW subroutine 800 of FIG. 8. Subroutine 2200 then finds the end of the chain of deferral at 2205 by following the Deferred fields starting with UIDWa until an empty Deferred field is found, and this UIDW (e.g. UIDWe) with an empty Deferred field is the end of the chain of deferral. This ending UIDW is displayed at 2206. Once the ending UIDW is displayed, subroutine 2200 asks the UIP if the UIP wishes to move the deferral of UIDWd to the UIDWe at 2207 and awaits a response from the UIP at 2208. Based on the UIP's response at 2209, the deferral link is either declined or accepted at 2212 or 2210. For example, if a UIP decides to accept the Deferral Link Update and move their deferral to the end of the chain, a deferral link update subroutine 2300 of FIG. 23 is called at 2210 to perform that action and subroutine 2200 is subsequently exited at 2210. Otherwise the request is declined at 2212 and subroutine 2200 is exited at 2213.

FIG. 23 depicts a flow diagram of a deferral link update subroutine 2300 that shows a process for accepting a Deferral Link Update, whereby the Deferred field of the UIDWd in question is changed to point to the end of the deferral chain, UIDWe as described above. At 2301, subroutine 2300 is initiated and inputs a deferral link update containing UIDWa and UIDWd at 2302. Next at 2303, subroutine 2300 additionally inputs a deferral chain ending UIDW (e.g. UIDWe) and the identifier of UIDWe is placed in the Deferred metadata field of UIDWd at 2304. The identifier of UIDWd is then placed in the UIDWe metadata field, “Deferred to this” at 2305. The Deferral Link Update is marked as accepted at 2306 and if any UIDWs are currently deferred to UIDWd, then at 2309 a new Deferral Link Update is sent to each UIP that has a UIDW deferred to UIDWd, and subroutine 2300 is exited at 2310. Otherwise, subroutine 2300 is exited at 2308 if no UIDWs are already deferred to UIDWd.

The description of the present invention provided above provides a valuable means for people to interpret the trustworthiness of sources of information in the Internet and other computer networks by viewing their attitudes and logical thoughts that they use to connect their thoughts about individual pieces of digital content.

Thus, specific compositions and methods of the present invention have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method of connecting discrete pieces of digital content to create a premise tree structure of said digital content comprising:
providing a computer for creating digital content, providing an identification system configured to uniquely identify individual persons within a domain,
providing a communication path with a server computing device,
accepting a new digital content from a uniquely identifiable person over said communication path, wherein said digital content is stored in a new uniquely identifiable digital work,
creating metadata for said digital content,
accepting indentifying references to previously recorded digital works as premises to said new work,
adding reference into a premise list in said metadata of said new work for each of said premises for which said creator is not identified in said disagreement list of said premise,
adding to said metadata an identifier for said person in said domain as creator of said new work, and
storing said metadata and a uniquely identifiable representation of said content in memory of said server as said new work, wherein each said digital work may reference a plurality of prior said digital works through said tree of said premises that may exist through a plurality of said references in said metadata of said digital work and indicating that said creator of said digital work does not disagree with any said premises in said tree.

2. The method of claim 1, further comprising:
presenting views of said premise tree in graphical form to a viewer from any person's point of view upon request, wherein said viewer can see the full context of the subject under discussion.

3. The method of claim 1, further comprising:
calculating an indiscretion level for uniquely identifiable digital works, wherein said indiscretion level is determined by said server using rules of premise logic, and
presenting visual cues to said indirection level.

4. The method of claim 1, wherein said metadata comprises a bias counter, and wherein said bias counter is incremented to indicate use of said premise.

5. The method of claim 1, wherein the metadata of said new work is associated with a conversational thread of at least one premise in said premise list of said new work.

6. The method of claim 1, further comprising:
accepting an attitudinal request indicating either an agreement or a disagreement with at least one target work,
recording said attitudinal request in said metadata of said target work,
whereby said people can express new or changed attitudes towards any said digital work created by any said creator.

7. The method of claim 6, wherein the accepting further comprising accepting a new digital content to be recorded in a new uniquely identifiable digital work, wherein said digital content is included in said disagreement request as a disagreement work, and further comprising:
adding an identifiable reference for each new uniquely identifiable work to a parent work field of said metadata of said uniquely identifiable work.
adding an identifiable reference for said disagreement work to said disagreement list in said metadata of said target work,
whereby a logical relationship is created between two said digital works for detecting contradictions.

8. The method of claim 7, further comprising:
adding a reiteration flag to said metadata of said disagreement work wherein repeated disagreements with the same work by the same person are categorized as reiterations.

9. The method of claim 6, wherein the accepting further comprising accepting a new digital content to be recorded in a new uniquely identifiable digital work, and wherein said digital content is included in an agreement request, and further comprising:
adding an identifying reference of said target work to said premise list in said metadata of said new uniquely identifiable digital work, and wherein said target work becomes a premise of said new uniquely identifiable digital work.

10. The method of claim 6, further comprising:
searching a disagreement list in said metadata of each premise work,
removing all instances of said identifier of said requestor from each disagreement list,
marking all digital works referenced in said disagreement list and created by said requestor as retracted, and
retracting contradictions of said agreement request.

11. The method of claim 6, further comprising:
searching said metadata of a disagreement attitudinal request for a found work,
marking each found work as retracted in said metadata of said found work,
searching said target work and said premise tree of said target work for all previously recorded agreement requests, and
retracting contradictions of said disagreement attitudinal request.

12. A method of representing a plurality of digital contents created by a multitude of people by only one of said pieces of digital content, comprising:
providing a computer for creating digital content,
providing an identification system configured to uniquely identify individual persons within a domain,
providing a communication path with a server computing device,
accepting digital content from a uniquely identifiable person over said communication path,
creating metadata for said digital content,
adding to said metadata an identifier for said person in said domain as creator of said digital work,
storing said metadata with a uniquely identifiable representation of said digital content in memory of said server as a uniquely identifiable digital work,
accepting a request containing references to a plurality of digital works to combine into one representation,
presenting each said creator of each said digital work referred to in said request an option to defer said digital work to another said digital work referred to in said request,
inserting an identifying reference to a different digital work into the deferral field of said metadata of said digital work deferring said digital work to said different digital work if said request is accepted by said creator, and
inserting said identifying reference to said digital work into the list of deferrals of digital works in the metadata of said different digital work if said request is accepted by said creator, wherein a plurality of said digital works are represented by only one of said digital works.

13. The method of claim 12, wherein the number of independent representations of similar digital content is reduced, and further including:
creating a chain of deferred digital works by following said deferred fields of said digital works starting at a starting digital work until a different ending digital work is found with no identifier in said deferral field of said metadata of said ending digital work,
allowing said creator of said starting digital work in said chain to change the said deferral field of said metadata of said starting digital work to said identifying reference of said ending digital work in said chain if the identifier of said ending digital work is different than said deferral field in said metadata of said starting digital work,
whereby a multitude of said chains of said digital works are represented by a single said digital work.
